(19) United States
(12) Patent Application Publication
(10) Pub. No.: US 2015/0073089 A1
(43) Pub. Date: Mar. 12, 2015

(54) MOLDINGS MADE FROM PELLETS AND 2K-PU ADHESIVES COMPRISING ALIPHATIC ISOCYANATES

(71) Applicant: Henkel AG & Co. KGaA, Duesseldorf (DE)

(72) Inventors: Helga Garmann, Hilden (DE); Claus-Heinrich Puck, Ellwangen (DE); Thierry Pasquier, Arnas (FR); Antonio Lourenco, Ega (PT)

(21) Appl. No.: 14/546,389

(22) Filed: Nov. 18, 2014

Related U.S. Application Data
(63) Continuation of application No. PCT/EP2013/060722, filed on May 24, 2013.

(30) Foreign Application Priority Data
May 24, 2012 (DE) 102012208689.7

(51) Int. Cl. C08L 97/00

(52) U.S. Cl. CPC C08L 97/007
USPC 524/703

(57) ABSTRACT

Moldings comprising pellets of natural raw materials having a particle size from 0.5 to 15 mm, bonded with a two-component polyurethane adhesive, said adhesive containing oligomers of aliphatic isocyanates as the isocyanate component.

The invention relates to elastic moldings made from cellulose- or lignin-containing pellets, which are adhesively bonded with two-component polyurethane adhesives comprising aliphatic isocyanates. The invention relates moreover to a method for adhesively bonding pellets of natural raw materials, such as cellulose- or lignin-containing materials.

WO2008/048129 describes cork stoppers consisting of pelletized cork with an adhesive. The selection of the cork pellets is described; the adhesive is generally described as a polyurethane adhesive produced with TDI or MDI.

WO2011/112813 describes adhesively bonded objects made from elastomeric pellets or cellulose-containing pellets, an adhesive based on polyols and an isocyanate-containing prepolymer being described. Aromatic isocyanates based on MDI are used as the isocyanates.

WO2007/047073 describes adhesively bonded objects consisting of pellets and adhesives. These are described in such a way that polyether polyols having a functionality from 1 to 6 must be included as the polymer constituent, said polyols having amino groups. Organic pellets and inorganic pellets are listed as the pellets.

WO 00/64647 describes a method for producing a coating on a substrate, the purpose of said coating being to prevent the diffusion of taste-bearing or odor-bearing compounds. The polymer that is present in the coating is intended to prevent the migration of constituents. Various polymers are listed in said document.

DE 10 2006 016 054 A1 discloses a method for coating cork stoppers with liquid reactive polyurethane coating agents, the coating serving to retain aroma-bearing substances from the cork. One-component and two-component polyurethane adhesives based on aliphatic, cycloaliphatic, arylaliphatic or aromatic polyvalent isocyanates can be used here. More specifically, one-component and two-component polyurethane adhesives based on aromatic isocyanates are disclosed in the embodiment examples.

DE 10 2008 026 266 A1 describes moldings made from pellets of olive stones and crosslinked adhesives, characterized in that pellets with a particle size below 10 mm are included, and reactive adhesives selected from two-component epoxide adhesives, two-component polyurethane adhesives or one-component polyurethane adhesives are selected as adhesives, 5 to 100% of adhesive being used relative to 100% pellets. Aromatic; aliphatic or cycloaliphatic diisocyanates or triisocyanates are mentioned as isocyanates that are suitable for the polyurethane adhesives. Aromatic isocyanates are preferred. More specifically, two-component polyurethane adhesives based on MDI are disclosed in the embodiment examples. The moldings are used as a flooring element or soundproofing element.

EP 1270703 describes adhesively bonding the underside of cork stoppers to disks of natural cork, a one-component polyurethane hot-melt adhesive being described as the adhesive. Such hot-melt adhesives are solid at room temperature. The one-component polyurethane hot-melt adhesives can be based on aromatic, aliphatic or cycloaliphatic diisocyanates. The embodiment example is based on MDI.

For the adhesive bonding of natural materials made from pellets to form moldings, the field of application must be taken into consideration when choosing the adhesive. For example, toxic substances should not be used for products which come into contact with the skin or with foodstuffs. Specific technical requirements have to be satisfied. One requirement, for example, is that stoppers or floor coverings made from natural raw materials, for example cork, must have an elastic structure. Likewise, cork stoppers must fit securely in the bottle. The adhesive bond must be durable, even under exposure to moisture, and must not exude constituents onto the surface of the bonding layer. If solvent-containing adhesives are used, a long crosslinking and drying time is usual. Adhesive bonding with polyurethane hot-melt adhesives requires elevated temperatures on application, and this is technically complicated. Furthermore, the subsequent crosslinking process in the molding is dependent on the diffusion of water as the crosslinking substance, which requires relatively long crosslinking times.

The object of the present invention is therefore to provide moldings made from plant-based raw materials, in particular cork, together with a method for the production thereof, in which pellets of said plant-based raw materials, thus in particular cork pellets, are adhesively bonded with a liquid, reactive adhesive. A thorough mixing of the adhesive and pellets should be ensured. Moreover a rapid, controlled crosslinking should be made possible.

The moldings obtained should have a high elasticity, such that a contraction in volume under pressure is reversible without damaging the adhesive bond. Migration-capable constituents, such as monomeric isocyanates for example, should be avoided as far as possible. Toxic substances such as TDI, for example, should not be used. A migration of possible taste-bearing or odor-bearing compounds, such as trichloroanisole for example, from the pellets should preferably be suppressed.

The object is achieved by a molding comprising pellets of plant-based raw materials, in particular cork pellets, having a particle size from 0.5 to 15 mm, bonded with a two-component polyurethane adhesive, said adhesive being liquid at room temperature and containing oligomers based on aliphatic isocyanates as the isocyanate component.

The invention relates moreover to a method for adhesively bonding pellets of natural, plant-based raw materials to form moldings, wherein a liquid two-component polyurethane adhesive consisting of a polyol component and an isocyanate component is mixed with the pellets in an amount such that the pellets are encapsulated by the adhesive, the mixture is shaped and then cured at elevated temperature, an adhesive according to the invention being used.

Pellets made from natural raw materials are one constituent of the moldings. They can be particulate or fibrous materials, which can be obtained from sustainable raw materials, in particular plant-based materials. They are preferably cork pellets. These pellets are produced from natural cork, for example also as a byproduct of cork processing. However, portions of other plant-based raw materials made from cellulose or lignin can also be used. Plant-based materials, for example cotton, hemp, bast, sisal, coconut fibers, yucca fibers or manila hemp, pellets made from coconut shells or nut shells, are suitable as the starting material; these can also be take the form of a mixture. It is convenient according to the invention for at least 50 wt. % of the pellets to consist of cork; cork pellets can also be used exclusively. The constituents should be ground. The pellet particles should have a particle size from 0.5 to 15 mm, in the form of fibers, chips, powders or pellets, in particular from 1.0 mm to 10 mm. The particle size is determined by screen analysis, as described in the standards DIN 66165-1:1987-04 and DIN 66165-2:1987-04. Pellets with particle sizes within a desired range can be obtained for example by separating pellet particles which are too small or too large from the material being screened, using two screens of differing sizes. Different particle sizes can thus also be mixed together.

The two-component polyurethane adhesives that are suitable according to the invention consist of two components which are stable if stored separately. Component A should be a component comprising one or more polyols, which on average have 2 to 10 OH groups. Component B contains at least one oligomeric compound based on aliphatic diisocyanates, wherein proportions of aromatic polyisocyanates can optionally also be included. Both components A and/or B can additionally contain further auxiliary substances and additives, which modify the properties of the adhesive.

In the context of the invention a multiplicity of polyfunctional alcohols are suitable for producing the OH component. These should have 2 to 10, in particular from 2 to 6 OH groups per molecule. The compounds having a plurality of OH groups can be examples bearing terminal OH groups or compounds having lateral OH groups distributed along the chain. The OH groups are those which are capable of reacting with isocyanates. They can be primary, secondary or tertiary OH groups, primary or secondary OH groups being preferred, however. Examples of suitable polyols are those based on polyethers, polyalkylenes or polyesters.

Suitable polyols are for example aliphatic and/or aromatic alcohols having 2 to 6, preferably 2 to 4 OH groups per molecule. The OH groups can be both primary and secondary. The suitable aliphatic alcohols include for example diols such as ethylene glycol, propylene glycol, butanediol-1,4, pentanediol-1,5, hexanediol-1,6, and higher homologs or isomers thereof. Glycerol, trimethylolpropane or pentaerythritol, for example, are suitable as polyhydric polyols. Higher-functional sugar alcohols can also be used, for example hydrogenated sugar alcohols such as sorbitol, inositol, mannitol, threitol, erythritol, xylose, lyxose, glucose, galactose, mannose, sucrose, lactose, trehalose, maltose.

Polyester polyols are moreover suitable. Such polyester polyols comprise the reaction products of polyfunctional, preferably difunctional alcohols, optionally together with small amounts of trifunctional alcohols, and polyfunctional, preferably difunctional and/or trifunctional carboxylic acids. Instead of free polycarboxylic acids, the corresponding polycarboxylic anhydrides or corresponding polycarboxylic acid esters with alcohols having preferably 1 to 3 C atoms can also be used. In particular, hexanediol, butanediol, propanediol, ethylene glycol, 1,4-hydroxymethyl cyclohexane, 2-methyl-1,3-propanediol, triethylene glycol, tetraethylene glycol, ethylene glycol, polyethylene glycol, dipropylene glycol, polypropylene glycol, dibutylene glycol and mixtures of different alcohols are suitable for producing such polyester polyols. The polycarboxylic acids can be aliphatic, cycloaliphatic or aromatic, for example azelaic acid, suberic acid, sebacic acid, maleic acid, fumaric acid, dimer fatty acid or trimer fatty acid. The specified acids can be used individually or as mixtures of two or more thereof. Polylactones, for example polyesters based on ε-caprolactone, are a further group of suitable polyester polyols. Such OH-functional polyester polyols are known to the person skilled in the art.

Polyester polyols of oleochemical origin can also be used, however. Such polyester polyols can be produced for example by complete ring opening of epoxidized triglycerides of a fat mixture containing at least some olefinically unsaturated fatty acids with one or more alcohols having 1 to 12 C atoms, followed by partial interesterification of the triglyceride derivative to form alkyl ester polyols having 1 to 12 C atoms in the alkyl residue. Examples of such polyols are castor oil or dimer diols.

Polyether polyols as reaction products of low-molecular-weight polyfunctional alcohols with alkylene oxides are suitable in particular. The alkylene oxides preferably have 2 to 4 C atoms. The reaction products of ethylene glycol, propylene glycol, the isomeric butanediols, hexanediols or 4,4′-dihydroxydiphenylpropane with ethylene oxide, propylene oxide, butylene oxide or mixtures of two or more thereof, for example, are suitable. Moreover, the reaction products of polyfunctional alcohols such as glycerol, trimethylolethane or trimethylolpropane, pentaerythritol or sugar alcohols with the cited alkylene oxides to give polyether polyols are also suitable. Further polyols that are suitable within the context of the invention are formed by polymerization of tetrahydrofuran (poly-THF). Polyether polyols having 2, 3 or 4 OH groups are preferred. Suitable polyether polyols are known to the person skilled in the art.

The functionality of the polyols should on average be from 2 to 6, in particular above 2.4. Mixtures can also be used, wherein individual constituents can contain a differing number of OH groups. It is convenient to use no polyols containing amino groups. A catalytic effect of the amines can be avoided in this way. Polyether polyols and/or oleochemical polyols are suitable in particular. These should have hydroxyl values from 50 to 400, preferably from 100 to 300 (mg KOH/g solids). The hydroxyl values can be determined in accordance with DIN 53240:1971-12. The number-average molecular weight Mn should preferably be below 5000 g/mol, but in particular between 400 and 2500 g/mol. It is determined by gel permeation chromatography (GPC), with polystyrene as the standard. The mixture of polyols should be liquid. Such polyols are available commercially.

An adhesive that is suitable according to the invention must contain as the second constituent an oligomeric aliphatic polyisocyanate as component B. These are difunctional and polyfunctional isocyanate oligomers. The oligomers of aliphatic isocyanates for use as polyisocyanates are understood to be the uretdiones, carbodiimides, uretonimines, isocyanurates or iminooxadiazine dione derivatives obtainable by dimerization, trimerization or oligomerization of at least 2, preferably 2 to 20, in particular preferably 2 to 10, most particularly preferably 2 to 6 molecules of aliphatic and/or cycloaliphatic monomeric diisocyanates.

Furthermore, the oligomers of aliphatic isocyanates for use as polyisocyanates are understood to be the allophanates or biurets obtainable by reacting at least 2, preferably 2 to 20, in particular preferably 2 to 10, most particularly preferably 2 to 6 molecules of aliphatic and/or cycloaliphatic monomeric diisocyanates with alcohols or water in an amount of less than 30 wt. %, relative to the amount of diisocyanates used.

The isocyanates that are suitable for forming the oligomers of aliphatic isocyanates are aliphatic and/or cycloaliphatic isocyanates, such as hydrogenated or partially hydrogenated MDI (H12MDI, H6MDI), xylylene diisocyanate (XDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, butane-1,4-diisocyanate, (HDI), dicyclohexylmethane diisocyanate, tetramethylene diisocyanate, hexamethylene diisocyanate, undecane diisocyanate, dodecamethylene diisocyanate, 2,2,4-trimethylhexane-2,3,3-trinnethylhexamethylene diisocyanate, cyclohexane-1,4-diisocyanate, ethylene diisocyanate, phthalic acid bis-isocyanatoethyl ester, trimethylhexamethylene diisocyanate, 1,4-diisocyanatobutane, 1,12-diisocyanatododecane and dimer fatty acid diisocyanate, lysine diisocyanate, 4,4′-dicyclohexylmethane diisocyanate, 1,3-cyclohexane or 1,4-cyclohexane diisocyanate.

Polyisocyanates, for example, which are formed by trimerization of diisocyanates, isocyanurates for example, are suitable as at least trifunctional oligomeric isocyanates.

In one embodiment TMXDI, HDI or IPDI are suitable in particular as monomeric isocyanates. Particularly preferred oligomers are uretdiones, carbodiimides, allophanates, biurets, isocyanurates, uretonimines or iminooxadiazine dione derivatives of the specified isocyanates. Isocyanurates, biurets, carbodiimides or uretonimines, based in particular on HDI or IPDI, are preferred in particular as oligomers of aliphatic isocyanates.

In another embodiment it is possible to add, in addition to the aliphatic isocyanates, proportions of aromatic diisocyanates, carbodiimides or polyisocyanates thereof. The isomers of MDI, such as 2,4′- or 4,4′- or polymeric MDI, are suitable in particular. The amount can be up to 80 mol % of all NCO groups.

In another embodiment the isocyanates of component B should contain no substantial proportions of monomeric, in particular volatile, diisocyanates. This can be achieved by selecting polymeric or oligomeric isocyanate derivatives. In another embodiment component B can contain trifunctional isocyanate derivatives, such as those formed by trimerization or oligomerization of diisocyanates. Trimers of HDI or IPDI are most particularly preferred. The amount of isocyanates is selected such that the NCO:OH ratio of components A to B is between 0.8:1 and 1.1:1.

Suitable polyurethane adhesives can be produced according to the invention with the reactive constituents. These can optionally additionally contain additives to influence processing properties of the polyurethane adhesive. Additives are for example catalysts, such as tin compounds such as DBTL, iron compounds such as Fe acetyl acetonate, or tertiary amines such as DABCO; rheology aids, viscosity regulators, pH regulators; defoaming agents, emulsifiers, adhesion promoters, pigments, such as titanium dioxide, carbon black, silicas, phyllosilicates; hollow microbeads; dyes; stabilizers, such as antioxidants or light stabilizers; waxes, such as natural waxes, chemically modified waxes and synthetic waxes; flow control agents, degassing agents or tackifiers, such as aromatic, aliphatic or cycloaliphatic hydrocarbon resins.

Such additives are known to the person skilled in the art. The additives should be chosen such that they do not migrate or evaporate from the polyurethane adhesive layer after crosslinking. Volatile compounds such as organic solvents for example, should preferably not be included. The additives or auxiliary substances can be contained in a suitable two-component polyurethane adhesive in an amount up to 20 wt. %, preferably up to 10 wt %, in particular up to 3 wt. %, relative to the adhesive.

Since a use of the adhesively bonded moldings in food packaging is provided in a preferred embodiment, it is convenient to use appropriate raw materials that are non-toxic or declared fit for human consumption; for example, no heavy metal catalysts such as Sn compounds should be included. Care should be taken to ensure that the adhesive contains the smallest possible proportions of migration-capable, low-molecular-weight substances. In particular, no substances should be dissolved from the coating on contact with an aqueous filling. For example, no aromatic amines should be present after the adhesive is crosslinked.

The adhesive that is used according to the invention is a two-component polyurethane adhesive. It must be liquid at room temperature (25° C.). The components are mixed shortly before the adhesive bonding process. In this case a suitable viscosity must be determined immediately after mixing. A range from 500 to 5000 mPas at a temperature of 25° C. is preferred (viscosity measured with a Brookfield RVT in accordance with EN ISO 2555).

The viscosity of the coating agent is adapted to the application method. Immediately after the components are mixed together, the viscosity of the adhesives that are suitable according to the invention should be between 300 mPas and 10,000 mPas at the application temperature, which is below 50° C. A range from 500 to 5000 mPas at a temperature between 15° C. and 50° C., in particular 25° C., is preferred (viscosity measured with a Brookfield RVT in accordance with EN ISO 2555). If polyurethane adhesives which are more highly viscous at room temperature are used, it is convenient to raise the coating temperature to ensure a sufficiently low viscosity of the adhesive on application.

The moldings according to the invention are produced by mixing and adhesively bonding the pellets. The pellets are selected in the appropriate particle size and pre-mixed. This mixture is then combined with the proportion of the pre-mixed two-component polyurethane adhesive, mixed and then shaped into a molding. The mixture then crosslinks to form a crosslinked molding.

The amount of the two-component polyurethane adhesive should preferably be between 10 and 50 wt. %, in particular between 10 and 30 wt. %, relative to the adhesive/pellets mixture. It is advantageous to use less adhesive in the case of coarser pellets, while with finer pellets it is convenient to use a larger amount of adhesive: for example approx. 20-30% adhesive for pellets with a particle size in the range below 2 mm and approx. 10-20% adhesive for pellets in the range above 5 mm.

The amount of the mixture of pellets and two-component polyurethane adhesive is preferably 50 to 100 wt. %, more preferably 80 to 100 wt. % and still more preferably 90 to 100 wt. %, relative to the molding.

In one embodiment the molding contains 10 to 30 wt. % of two-component polyurethane adhesives and 90 to 10 wt. % of pellets of plant-based raw materials, relative to the molding.

As a consequence of the particle shape of the pellets, the crosslinked moldings may still contain voids. These are closed, and no through channels should be formed. The voids also increase the elasticity of the adhesively bonded moldings.

The invention also provides a method for adhesively bonding pellets of natural raw materials, in particular cork pellets, wherein a reactive two-component polyurethane adhesive that is suitable according to the invention is used. The pellets are selected in the appropriate size distribution. The two-component polyurethane adhesive is premixed in suitable proportions. The amount of the polyurethane adhesive should be 10 to 30 wt. % of the total amount of pellets/adhesive. The polyurethane adhesive can be applied by known methods, for example by spraying, dipping, extrusion or drum coating. Here the pellet particles are moved and coated with an adhesive layer, preferably on all sides. As the polyurethane adhesive used according to the invention is liquid, a continuous coating is formed on the pellet particles. An at least partial film formation should be ensured. This can optionally be facilitated by heating the coating agent before application or by heating during the coating process, for example up to 50° C.

After producing a mixture of adhesive and pellets, for example cork pellets, the mixture is shaped and optionally compressed. The adhesive should then crosslink. The adhesive bonding or crosslinking of the moldings can be supported by known measures. For example, heating can be performed by IR radiation, by passing over heated gases or by heating the mold. The temperatures can be between 20° C. and 150° C., in particular between 80° C. and 140° C. The heating time can be from 2 min to 60 min. It must be ensured that the substrate does not undergo any negative changes at this temperature. Discoloration of the substrate material should also be avoided.

In one embodiment of the invention crosslinking can also be performed without catalysts.

In a special embodiment the moldings produced by the method according to the invention can be produced as a round or cylindrical body or as a thin sheet. It is also possible to produce moldings as a thick body, for example. The end product, for example a sheet or stopper, is then produced therefrom by methods known per se. The final shape can be produced by sawing, cutting or punching, for example. The size of the end products can vary within broad limits; for example floor tiles, insulating sheets or cork stoppers for bottles can be produced in the known dimensions. These have good properties, including a high elasticity.

In a particular embodiment cork sheets or cork stoppers are produced. It is optionally possible for a shaped cork stopper to be processed further. For example, it can be cleaned, ground or printed. A further pretreatment is not usually necessary. Further surface coatings can be applied to the cork stoppers if necessary.

The resulting moldings are very flexible. As a cork is introduced by compressing it and then moving it to its intended location, the bodies according to the invention should be adhesively bonded such that an elastic deformation is possible. The crosslinked adhesive must not be so brittle or so highly crosslinked that cracks and fractures can occur in the molding. However, crosslinking must be sufficiently complete that in particular no low-molecular-weight constituents are included which can migrate or be eluted by aqueous solutions. Through the choice of polyols and isocyanates an adhesive is provided such that the required application-related properties are satisfied.

One important property is the compressibility of the adhesively bonded and crosslinked molding, in particular of the stopper. This should ensure a deformation and subsequent recovery to the original shape. The ratio K₁ of F (compression) to F (recovery) is determined (method of determination for cork testing in accordance with Portuguese standard NP 2803, force measurement in accordance with NP 2803-3 (1996) at 23° C. and 50% relative humidity). The ratio K₁=F (compression): F (recovery) should be from 5 to 10. In such a case the adhesively bonded molding is stable and does not break or disintegrate. If the proportion of aromatic isocyanates in the adhesive is too high, the molding does not have an adequate recovery. If the crosslink density is too low, the recovery is likewise not sufficient. If the degree of crosslinking is too high, hard moldings are produced which are difficult to compress.

Moldings according to the invention have a good compressibility. Cork moldings adhesively bonded with the preferred embodiment of an adhesive containing aliphatic oligomeric isocyanates result in elasticity values which correspond to those of natural cork stoppers.

In particular, the adhesively bonded moldings according to the invention should contain no low-molecular-weight migratory substances. The water resistance can be increased through the choice of polyols. After crosslinking, the individual ingredients are compatible, they do not exude and they have no adverse effect on adhesion to the substrate materials. The polarity of the adhesive can be influenced through the choice of the polyols that are reacted with the isocyanates. Aliphatic components tend to produce non-polar properties, while polyols having ether or ester groups tend to be polar. A good adhesion to the pellets can be ensured in this way. A good adhesion to organic substrates is likewise ensured by the content of urethane groups. The adhesive layer can be given elastic properties in the same way.

A method according to the invention improves the production process. A homogeneous mixing of the starting materials is improved. Likewise, pollution of the ambient air with volatile monomeric isocyanates is reduced. An elastic, crosslinked product is obtained.

### Coating Method:

88 g of cork pellets having a particle size between 3 and 7 mm are introduced into a drum together with 12 g of an adhesive 1, 2, 3 or 4 and rolled. After a mixing time of 10 min the coated cork pellets are removed, introduced into a cylindrical mold and compressed. The body cures for 45 min at 130° C. The moldings that are produced are cylindrical (diameter 2.5 cm, length 10 cm) and can be trimmed to an appropriate size.

| | Adhesive | Adhesive | Adhesive | Adhesive 4 |
|---|---|---|---|---|
| | 1 | 2 | 3 | (comparison) |
| Polyether triol | 40 | — | — | — |
| (Mₙ 4800 g/mol) | | | | |
| Polyether triol | 60 | — | — | — |
| (Mₙ 750 g/mol) | | | | |
| Polyether triol | — | 50 | 100 | — |
| (Mₙ 1050 g/mol) | | | | |
| Castor oil | — | 50 | — | 100 |
| (Mₙ 1000 g/mol) | | | | |
| HDI isocyanurate | 60 | 60 | 30 | — |
| Polymeric MDI | — | — | 20 | 40 |
| Stabilizer | — | — | 0.5 | — |
| Viscosity 25° C. (mPas) | 1000 | 1200 | 800 | 750 |
| Ratio K₁ of F | 7 | 8 | 9 | 12 |
| (compression) to | | | | |
| F (recovery): | | | | |
| K₁ = F (compression):F | | | | |
| (recovery) | | | | |

What is claimed is:

1. A molding comprising pellets of plant-based raw materials having a particle size from 0.5 to 15 mm, bonded with a two-component polyurethane adhesive, said adhesive comprising a mixture of a polyol component and an isocyanate component comprising oligomers of aliphatic isocyanates.

2. The molding according to claim 1, wherein the adhesive is liquid at room temperature.

3. The molding according to claim 1, wherein the molding contains 10 to 30 wt. % of two-component polyurethane adhesives and 90 to 10 wt. % of pellets of plant-based raw materials.

4. The molding according to claim 3, wherein the pellets of plant-based raw materials are cork pellets.

5. The molding according to claim 4, wherein the two-component polyurethane adhesive contains polyols having an average functionality of between 2 and 6.

6. The molding according to claim 5, wherein up to 80 mol % of all NCO groups are NCO groups of MDI and derivatives thereof.

7. The molding according to claim 1, wherein isocyanurates, biurets, carbodiimides or uretonimines of an aliphatic diisocyanate based on HDI or IPDI are used as the isocyanate component.

8. The molding according to claim 1, wherein the adhesive is crosslinked.

9. The molding according to claim 8, wherein the crosslinked molding has an F (compression) to F (recovery) ratio K₁, i.e. K₁=F (compression): F (recovery), of 5 to 10 (method of determination for cork testing in accordance with Portuguese standard NP 2803, force measurement in accordance with NP 2803-3 (1996) at 23° C. and 50% relative humidity).

10. The molding according to claim 1, wherein the molding is a bottle stopper.

11. A method for producing a molding according to claim 1, comprising:
providing a liquid two-component polyurethane adhesive comprising a polyol component and an isocyanate component containing oligomers of aliphatic isocyanates;
Mixing the liquid two-component polyurethane adhesive with pellets of plant-based raw materials in an amount such that the pellets are encapsulated by the adhesive,
molding the mixture in a shape; and
curing the molded shape at elevated temperature.

12. The method according to claim 11, characterized in that 10 to 30 wt. % (relative to the molding) of the two-component polyurethane adhesive is mixed with the pellets while being agitated.

13. The method according to claim 11, wherein curing is performed at a temperature from 80° C. to 140° C.

14. The method according to claim 11, wherein immediately after being mixed the two-component polyurethane adhesive has a viscosity below 5000 mPas (25° C.) (viscosity measured with a Brookfield RVT in accordance with EN ISO 2555:1999).

15. A food package comprising the molded article of claim 10.
